(19) United States
(12) Patent Application Publication
(10) Pub. No.: US 2026/0093629 A1
(43) Pub. Date: Apr. 2, 2026

(54) CACHE COHERENTLY ROUTING DATA OF DEVICES TO DIFFERENT INDICATED DESTINATION LOCATIONS

(71) Applicant: Intel Corporation, Santa Clara, CA (US)

(72) Inventors: Kishore Karthikeyan, Gilbert, AZ (US); Niall McDonnell, Limerick (IE); Yen-Cheng Liu, Portland, OR (US); Daniel Joe, Sacramento, CA (US); Naveen Lakkakula, Chandler, AZ (US); Kapil Sood, Washougal, WA (US); Chitra Natarajan, Queens Village, NY (US)

(21) Appl. No.: 18/900,365

(22) Filed: Sep. 27, 2024

(51) Int. Cl. G06F 12/0815

(52) U.S. Cl. CPC G06F 12/0815

(57) ABSTRACT

An apparatus of an aspect includes a cache coherency protocol controller to receive a first packet of a cache coherency protocol. The first packet is to have been transmitted from a device over a communication link. The first packet has one or more bits to indicate destination location where data from the device is to be routed. The apparatus also includes circuitry coupled with the cache coherency protocol controller to receive the first packet. The circuitry is to generate a second packet based on the first packet. The second packet is to indicate the destination location. The apparatus also includes a fabric coupled with the circuitry to receive the second packet. The fabric is to route the data to the destination location indicated by the second packet. In one aspect, the cache coherency protocol is a CXL.cache cache coherency protocol. Other apparatus, methods, and systems are also disclosed.

### BACKGROUND

### Background Information

Compute Express Link (CXL) is a communication link or interconnect technology designed to improve the ability of an attached device to access resources of a host processor and/or for the host processor to access resources of the attached device. CXL may be used to provide a discrete or on-package link that may support one or more protocols. One such protocol is a cache coherency protocol referred to as “CXL.cache” to support device caching of host memory. Another such protocol is a non-coherent memory access protocol referred to as “CXL.mem” to support device-attached memory. Another such protocol is a non-coherent input/output (I/O) protocol referred to as “CXL.io” with enhancements for accelerator support. CXL.io is based on Peripheral Component Interconnect Express (PCIe). Depending on the particular implementation, all three of these CXL protocols (e.g., CXL.io, CXL.mem, and CXL.cache) or only a subset (e.g., CXL.cache) may optionally be utilized to provide a path for an attached device to access resources of a host processor and/or for the host processor to access resources of the attached device. Further details of CXL, if desired, are available in the Compute Express Link (CXL) Specification, Revision 3.1, Version 1.0, published by the Compute Express Link Consortium, Inc., published on Aug. 7, 2023 (hereinafter referred to simply as “the CXL specification”).

### BRIEF DESCRIPTION OF THE DRAWINGS

Various examples in accordance with the present disclosure will be described with reference to the drawings, in which:

FIG. 1 is a block flow diagram of an embodiment of a method of cache coherently routing data of a device attached to a host by a communication link to an indicated destination location of a host.

FIG. 2 is a block diagram of a computer system including an embodiment of a host or other apparatus and an embodiment of a device that are coupled by a communication link.

FIG. 3 is a block diagram of a computer system including an embodiment of a host processor and an embodiment of a CXL device that are coupled by a CXL link.

FIG. 4 is an example embodiment of a suitable slot format for a CXL.cache flit and/or packet.

FIG. 5 is a block diagram of a computer system including a more detailed embodiment of a host processor and a more detailed embodiment of a CXL device that are coupled by a CXL link.

FIG. 6 illustrates an example computing system.

FIG. 7 illustrates a block diagram of an example processor and/or System on a Chip (SoC) that may have one or more cores and an integrated memory controller.

FIG. 8(A) is a block diagram illustrating both an example in-order pipeline and an example register renaming, out-of-order issue/execution pipeline according to examples.

FIG. 8(B) is a block diagram illustrating both an example in-order architecture core and an example register renaming, out-of-order issue/execution architecture core to be included in a processor according to examples.

FIG. 9 illustrates examples of execution unit(s) circuitry.

FIG. 10 is a block diagram of a register architecture according to some examples.

FIG. 11 illustrates examples of an instruction format.

FIG. 12 illustrates examples of an addressing information field.

FIG. 13 illustrates examples of a first prefix.

FIGS. 14(A)-(D) illustrate examples of how the R, X, and B fields of the first prefix in FIG. 13 are used.

FIGS. 15(A)-(B) illustrate examples of a second prefix.

FIG. 16 illustrates examples of a third prefix.

FIG. 17 is a block diagram illustrating the use of a software instruction converter to convert binary instructions in a source instruction set architecture to binary instructions in a target instruction set architecture according to examples.

### DETAILED DESCRIPTION OF EMBODIMENTS

Disclosed herein are methods, devices, apparatus, and systems to cache coherently route data of a device attached to a host by a communication link to different specified or indicated destination locations of the host. In the following description, numerous specific details are set forth (e.g., specific communication links, protocols, device types, microarchitectural details, sequences of operations, etc.). However, embodiments may be practiced without these specific details. In other instances, well-known circuits, structures, and techniques have not been shown in detail to avoid obscuring the understanding of the description.

One challenge with certain cache coherency protocols for communication links is that they do not incorporate a mechanism to allow a device attached to a host by a communication link to cache coherently route data of the device to different specified or indicated destination locations of the host. As one example, the cache coherency protocol CXL.cache used for certain CXL communication links does not incorporate a mechanism to allow data of a CXL device attached to a host processor by a CXL link to cache coherently route data of the CXL device to different specified or indicated destination locations of the host processor. By way of example, where the data gets routed may be fixed (e.g., fixed for the implementation and/or hardware, according to a fixed policy, etc.). In any event, the CXL device is not able to specify or control where the data gets routed. One drawback is that in at least some situations the data may be routed to a non-optimal destination location, which may result in one or more inefficiencies, such as, for example, increased latencies in accessing the data, increased amounts of data transfer, increased power consumption to access the data, etc. Accordingly, allowing a device attached to a host by a communication link to cache coherently route data of the device to different specified or indicated destination locations of the host would be useful and in at least some situations would be advantageous.

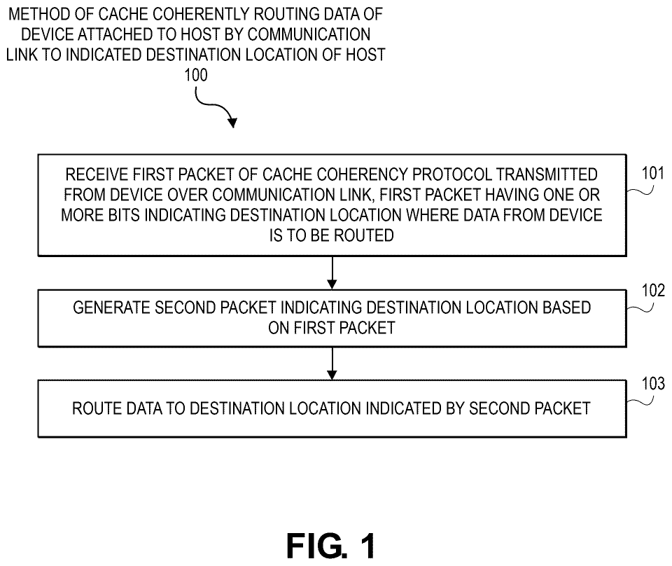

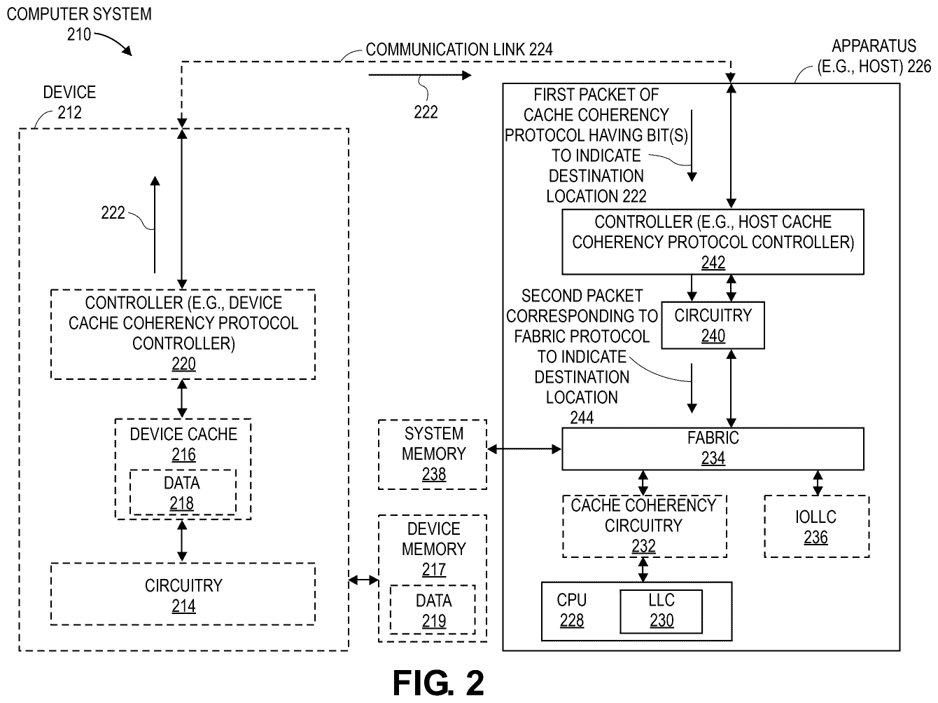

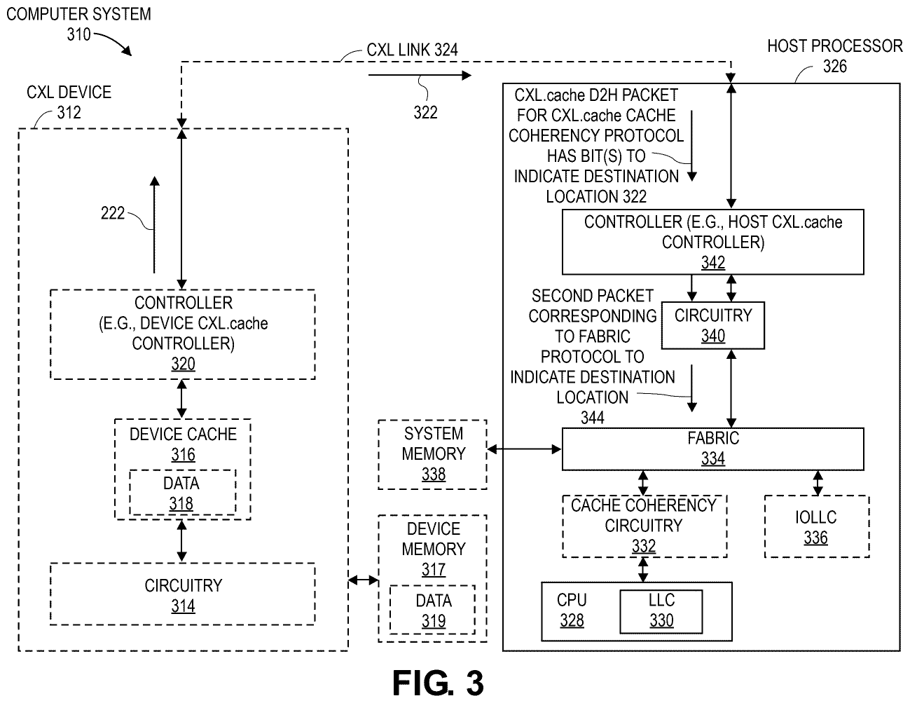

FIG. 1 is a block flow diagram of an embodiment of a method 100 of cache coherently routing data of a device attached to a host by a communication link to an indicated destination location of a host. In various embodiments, the method 100 may be performed by a host processor, an SoC, a host, or other apparatus. In some embodiments, the method 100 may be performed by and/or within the host or other apparatus 226 of FIG. 2 or the host processor 326 of FIG. 3. The components, features, and specific optional details described further below for the apparatus 226 and the host processor 326 also optionally apply to the method 100. Alternatively, the method 100 may optionally be performed by and/or within a similar or different host processor or other apparatus. Moreover, the apparatus 226 and the host processor 326 may perform methods the same as, similar to, or different than the method 100.

The method includes receiving (e.g., at a host processor, host, SoC, or other apparatus) a first packet of a cache coherency protocol that has been transmitted from a device over a communication link, at block 101. The first packet has one or more bits indicating a destination location where data from the device is to be routed.

In some embodiments, the cache coherency protocol is a CXL.cache cache coherency protocol and the first packet is a CXL.cache D2H (device to host) packet. In some embodiments, the one or more bits comprise at least one bit that the cache coherency protocol specifies is reserved. In some embodiments, the one or more bits comprise at least one bit that the cache coherency protocol specifies for a different purpose than for the indication of the destination location. In some embodiments, the one or more bits comprise a bit that the cache coherency protocol specifies as a non-temporal (NT) bit. In some embodiments, the one or more bits indicate the destination location as any one of at least a last level cache (LLC) of a central processing unit (CPU), an input/output last level cache (IOLLC), and optionally a third destination location (e.g., system memory of the CPU).

At block 102, a second packet is generated based on the first packet. The second packet indicates the same destination location. In some embodiments, the second packet is of a different type and/or is of a different protocol than the first packet. In some embodiments, the second packet is a fabric packet suitable for an on-die fabric.

At block 103, the data is routed to the destination location indicated by the second packet. In some embodiments, the destination location may be any one of at least a last level cache (LLC) of a central processing unit (CPU), an input/output last level cache (IOLLC), and optionally a third destination location (e.g., system memory of the CPU).

FIG. 2 is a block diagram of an embodiment of a computer system 210. In various embodiments, the computer system may represent a server, computer for a data center, workstation, network device (e.g., a router, switch, etc.), desktop computer, laptop computer, Smartphone, or various other types of computer systems. The computer system includes an embodiment of an apparatus 226 (e.g., a host processor, host, one or more system on chip (SoC)) and an embodiment of a device 212 that are coupled by a communication link 224 (e.g., one or more interconnects). The device and the communication link are shown in dashed lines to designate that some embodiments pertain to the apparatus 226 alone (e.g., before the apparatus is deployed in a system where it is coupled with the device via the communication link). The apparatus and the device may exchange data and messages over the communication link.

The apparatus incudes a central processing unit (CPU) 228. The CPU may include one or more cores (not shown). Each of the cores may include one or more caches at one or more cache levels. For example, each of the cores may include a level 1 (L1) cache and optionally a level 2 (L2) cache. The CPU also includes a shared last level cache (LLC) 230. If each of the cores includes an L1 cache and an L2 cache, then the LLC may be a shared level 3 (L3) cache. Or, if each of the cores includes an L1 cache but no L2 cache, then the LLC may be a shared L2 cache.

Cache coherency circuitry 232 is coupled with the LLC and the caches in the one or more cores. The cache coherency circuitry may maintain cache coherency for the LLC and the caches in the one or more cores. Maintaining cache coherency may include ensuring that the LLC and the caches in the one or more cores have a consistent or coherent view of the data they store. Cache coherency is needed to avoid incorrect execution that would generally result from inconsistent or incoherent data being stored in the caches (e.g., such as if one core uses an outdated copy of a cacheline by erroneously thinking it is current and valid when in fact another core had already modified that cacheline). An example of suitable cache coherency circuitry is snoop filter circuitry.

The apparatus also includes a fabric 234 (e.g., one or more buses or other interconnects) coupled with the cache coherency circuitry 232 and coupled with the CPU 228. An input/output last level cache (IOLLC) 236 is coupled with the fabric. The IOLLC may be used to cache data for the device 212 as well as other attached devices. When the apparatus 226 is deployed in the computer system 210 a system memory 238 may also be coupled with the fabric.

The device 212 may be any of a wide variety of different types of devices that may be coupled with the apparatus 226 via the communication link. Examples of suitable devices include, but are not limited to, accelerators, input/output (I/O) devices, memory devices, graphics processing units (GPUs) such as general-purpose GPUs (GPGPUs), field programmable gate arrays (FPGAs), application specific integrated circuits (ASICs), artificial intelligence (AI) accelerators, devices to connect the host or apparatus to a network (e.g., LAN adapters, network adapters, or other network interface controllers), and the like. As used herein, an accelerator may broadly represent a device that may be used by software running on the host processor to offload or perform a wide variety of different compute and/or I/O tasks. The device includes circuitry 214 of a type that depends upon the type of device (e.g., GPU circuitry, FPGA circuitry, ASIC circuitry, artificial intelligence circuitry, network controller circuitry, etc.). In some embodiments, the device may be a peripheral or external device. In other embodiments, the device may be in-package on a chiplet, system on a chip (SoC) or other die coupled by UCIe™ (Universal Chiplet Interconnect Express™) or other die-to-die interconnect to another chiplet, SoC, or other die having the CPU.

The device includes at least one device cache 216. The device cache may be used to cache or store data of the host or other apparatus 226. For example, data from the system memory may be cached in the LLC, the caches of the cores of the CPU, the IOLLC, the device cache, or any combination. The device cache may be cache coherent with the LLC, the caches of the cores of the CPU, and the IOLLC. Commonly, the cache coherency circuitry 232 of the host or apparatus may be used to maintain the cache coherency for the device cache, rather than the device having its own local cache coherency circuitry. By way of example, the cache coherency circuitry 232 may snoop the device cache, help to implement a cache coherency protocol for the device cache, indicate when cache lines of the device cache should be marked dirty, etc.

In some embodiments, the communication link 224 may optionally be encrypted, authenticated (e.g., the components at both ends of the link may be mutually authenticated), or both encrypted and authenticated, although this is not required. Encryption and/or authentication may help to maintain the security (e.g., confidentiality and trustworthiness) of the data conveyed on the communication link. In such cases, a cryptographic unit or circuit (e.g., an encryption/decryption and/or authentication unit or circuitry may be included at the end of the communication link in each of the device 212 and the apparatus 226. Other embodiments need not use encryption or authentication.

The device includes a controller (e.g., a device cache coherency protocol controller) 220 to implement a cache coherency protocol. Similarly, the host or other apparatus includes a controller (e.g., a host cache coherency protocol controller) 242 to implement the cache coherency protocol. The controllers may be used to perform cache coherent data exchanges between the device and the host or other apparatus. In some embodiments, the device 212 may coherently write or store data 218 from the device cache 216 and/or data 219 from the device memory 217 to the host or other apparatus 226. Some embodiments may allow the device 212 to cache coherently route this data to any one of a plurality of different specified or otherwise indicated destination locations of the host or other apparatus. In some embodiments, the device may be able to flexibly specify or otherwise indicate that such data be steered, directed, or otherwise routed to any one of the LLC 230, the IOLLC 236, or the system memory 238. At least conceptually, this may represent adding Intel® Data Direct I/O Technology (Intel® DDIO) like data steering capabilities to the cache coherent protocol where they did not previously exist.

As one example, the device may specify or otherwise indicate that the data is to be routed to the LLC if the device wants to provide the data to the CPU (e.g., for the CPU to process the data). Advantageously, this may offer one or more advantages compared to if the apparatus (e.g., fixedly or on its own) routed the data to certain other locations, such as, for example, the system memory or the IOLLC. By way of example, if the apparatus merely (e.g., fixedly or on its own) routed the data to the system memory, then the data would initially need to be written to the system memory and then subsequently read from the system memory into the CPU. Such writing of the data to the system memory and reading of the data from the system memory consumes additional memory access bandwidth not needed if the data were instead routed to the LLC, adds additional latencies associated with providing the data to the CPU, adds extra power consumption to write the data to the system memory and to read of the data from the system memory, and so on.

As another example, the device may specify or otherwise indicate that the data is to be routed to the IOLLC if the device wants to provide the data to another device (e.g., another attached device, a device on the SoC with the CPU, etc.). Advantageously, this may offer one or more advantages compared to if the apparatus (e.g., fixedly or on its own) routed the data to certain other locations, such as, for example, the system memory or the LLC.

By way of example, if the apparatus merely (e.g., fixedly or on its own) routed the data to the system memory, then the data would initially need to be written to the system memory and then subsequently read from the system memory into the other device. Such writing of the data to the system memory and reading of the data from the system memory consumes additional memory access bandwidth not needed if the data were instead routed to the IOLLC, adds additional latencies associated with providing the data to the other device, adds extra power consumption to write the data to the system memory and to read of the data from the system memory, and so on. In still other examples, it may be more appropriate and/or efficient for the device to write the data to the system memory (e.g., if the data is not going to be used soon). So, there may be advantages to allowing the device 212 to cache coherently steer, direct, or route the data to an indicated destination location of a plurality of different indicatable destination locations of the host or apparatus (e.g., any one of at least the LLC, the IOLLC, the system memory). Also, these are not the only destination locations that may be used. In other embodiments, the device may optionally be able to flexibly specify or otherwise indicate that the data be routed to additional and/or different destination locations, such as, for example, to an indicated cache level within an indicated core of the CPU (e.g., by indicating the L1 cache of an indicated core).

Referring again to FIG. 2, when the device writes or stores the data to the host or other apparatus, the controller (e.g., the device cache coherency protocol controller) may generate and/or transmit a first packet 222 toward the communication link 224. The first packet may correspond to and/or be a packet of the cache coherency protocol implemented by the controller. In some embodiments, as will be discussed further below, the controller may be a device CXL.cache controller, the cache coherency protocol may be a CXL.cache cache coherency protocol, and the first packet may be a CXL.cache D2H (device to host) packet, although the scope of the invention is not so limited. In some embodiments, the first packet may include information (e.g., one or more bits) to specify or otherwise indicate one of multiple possible destination locations where the data (e.g., the data 218 from the device cache or the data 219 from the device memory) is to be routed.

In various embodiments, the one or more bits may indicate any of at least one, two, three, four, or more than four different possible destination locations. In one example embodiment, the one or more bits may include a single bit that may have either a first binary value (e.g., be set to binary one) to indicate a first destination location or a second binary value (e.g., be cleared to binary zero) to indicate a second, different destination location. In another example embodiment, the one or more bits may include two bits that may have any one of a first binary value (e.g., 00) to indicate a first destination location (e.g., the LLC), a second binary value (e.g., 01) to indicate a second, different destination location (e.g., the IOLLC), a third binary value (e.g., 10) to indicate a third, still different destination location (e.g., the system memory), or a fourth binary value (e.g., 11) to indicate either a fourth, still different destination location or to indicate that no destination location is specified and/or that the host or other apparatus is allowed to choose on its own where the data is to be routed (e.g., a destination location fixed for the implementation or hardware, according to a fixed policy, etc.). In yet another example embodiment, the one or more bits may include three or more bits to indicate additional destination locations (e.g., to indicate a specific core, to indicate a specific cache level within a specific indicated core, etc.).

Diverse types of bits may be used to indicate the destination location in different embodiments. In some embodiments, the one or more bits may include at least one bit that the cache coherency protocol specifies as being reserved. For example, the cache coherency protocol may specify the format of packets, the packets may have one or more reserved bits or fields, and one or more of these reserved bits or fields may optionally be used to indicate the destination location. One possible advantage of using one or more reserved bits is that the controllers 220, 242 may simply ignore these fields, which may optionally allow existing controllers to be used to implement the flexible routing to different destination locations even though the cache coherency protocol does not incorporate a mechanism for such flexible routing. In some embodiments, the one or more bits may include at least one bit that the cache coherency protocol defines or specifics for a different purpose than for the indication of the destination location and this bit may be repurposed for the indication of the destination location. As one example, the one or more bits may include a non-temporal (NT) bit that the CXL.cache cache coherency protocol specifics should be used to indicate non-temporality (e.g., for purposes of evicting data from caches) rather than for the different purpose of indicating the destination location where the data is to be routed. Different combinations of these approaches are also possible. In some embodiments, the one or more bits may include any one, two, three, or more bits selected the following: (1) one or more bits that the cache coherency protocol specifics as being reserved; (2) one or more bits that the cache coherency protocol specifies for a different purpose than the indication of the destination location; (3) a bit that the cache coherency protocol specifics as a non-temporal (NT) bit; and (4) any combination thereof. In some embodiments, the destination location indicated by the one or more bits may depend upon an opcode of a command executed to transmit the data.

Referring again to FIG. 2, the first packet 222 may be sent or transmitted from the device 212 to the apparatus 226 over the communication link 224. The controller (e.g., the host cache coherency protocol controller) 242 may receive the first packet 222. The first packet may correspond to and/or be of the cache coherency protocol implemented by the controller. In some embodiments, the controller may be a host CXL.cache controller, the cache coherency protocol may be a CXL.cache cache coherency protocol, and the first packet may be a CXL.cache D2H (device to host) packet, although the scope of the invention is not so limited. In some embodiments, the first packet may include the previously described information (e.g., the previously described one or more bits) to specify or otherwise indicate the destination location out of multiple possible destination locations where the data (e.g., the data 218 from the device cache or the data 219 from the device memory) is to be routed.

The apparatus also includes circuitry 240 coupled with the controller 242 to receive the first packet 222. The circuitry may generate and output a second packet 244 corresponding to and/or of a different protocol (e.g., a fabric protocol) based on the first packet 222. The second packet may include information (e.g., one or more bits) to specify or otherwise indicate the same destination location that was indicated by the first packet. Since the first and second packets correspond to and/or are of different protocols the second packet will generally use a different set of one or more bits (e.g., different bit positions in the packet) to indicate the destination location. In some embodiments, the second packet may be for a proprietary fabric technology rather than a standardized one so that may be a great deal of flexibility in deciding which bits to use to indicate the destination location. In some embodiments, the destination location may be indicated in one or more steering tag (ST) bits of the second packets where these ST bits are also utilized to steer or route data for PCIe packets for Intel® Data Direct I/O Technology (Intel® DDIO), although the scope of the invention is not so limited. The circuitry may be aware of the one or more bits in the first packet, may examine and interpret the one or more bits in the first packet, may recognize a destination location indicated by the one or more bits in the first packet, and may include one or more bits or an indication or information in the second packet to indicate the same destination location.

The apparatus also includes the fabric 234 (e.g., one or more buses or other interconnects) coupled with the circuitry 240 to receive the second packet 244. The fabric may route the data 218 from the device cache or the data 219 from the device memory to the destination location indicated by the second packet. For example, in some embodiments, the fabric may route the data to any one of the LLC, the IOLLC, or the system memory. In other embodiments, other destination locations may optionally be used, as previously described. Advantageously, the ability for the device to flexibly indicate the destination location where the data is to be routed and for the apparatus to use the indication to flexibly route the data to the indicated destination location may help to improve efficiency in at least some situations, such as, for example, by reducing data access latency, reducing the number of data transfers, reducing power consumption needed to access data, improving throughput, etc.

FIG. 3 is a block diagram of an embodiment of a computer system 310. The computer system includes an embodiment of a host processor 326 and an embodiment of a CXL device 312 that are coupled by a CXL link 324. The CXL device and the CXL link are shown in dashed lines to designate that some embodiments pertain to the host processor 326 alone (e.g., before the host processor is deployed in the computer system where it is coupled with the CXL device via the CXL link).

The host processor includes a CPU 328 having an LLC 330, a cache coherent circuitry 332, an IOLLC 336, a fabric 334, circuitry 340, and a controller (e.g., a host CXL.cache controller) 342. The CPU, the cache coherent circuitry, the IOLLC, and the circuitry 340 are coupled with the fabric. A system memory 338 is also coupled with the fabric. The controller 342 is coupled with the circuitry 340. The CXL device includes circuitry 314, a device cache 316, and a controller (e.g., a device CXL.cache controller) 320. The device cache is coupled with the circuitry 314 and the controller 320. Unless otherwise specified, the CPU 328, the LLC 330, the cache coherent circuitry 332, the IOLLC 336, the fabric 334, the circuitry 340, the controller 342, the system memory 338, the circuitry 314, the device cache 316, and the controller 320 may respectively optionally be similar to or the same as (e.g., have any one or more characteristics that are similar to or the same as) the correspondingly named CPU 228, LLC 230, cache coherent circuitry 232, IOLLC 236, fabric 234, circuitry 240, controller 242, system memory 238, circuitry 214, device cache 216, and controller 220 of FIG. 2. Likewise, unless otherwise specified, the CXL device 312, the CXL link 324, and the host processor 326 may respectively optionally be similar to or the same as (e.g., have any one or more characteristics that are similar to or the same as) the device 212, the communication link 224, and the apparatus 226 of FIG. 2. For example, the computer system 310 may be of the same types previously described (e.g., server, desktop, etc.), the CXL device 312 may be of the same types previously described (e.g., GPUs, ASICs, FPGAs, may either be external/peripheral or in package on another chiplet, SoC, or die connected by UCIe or another die-to-die interconnect, etc.), and so on. To avoid obscuring the description, the different and/or additional characteristics of the embodiment of FIG. 3 will primarily be described, without repeating all the characteristics that may optionally be the same as or similar to those already described for the embodiment of FIG. 2. Also, as previously described, in some embodiments, the communication link 224 may optionally be encrypted, authenticated (e.g., the components at both ends of the link may be mutually authenticated), or both encrypted and authenticated, although this is not required. Encryption and/or authentication may help to maintain the security (e.g., confidentiality and trustworthiness) of the data conveyed on the communication link. In such cases, a cryptographic unit or circuit (e.g., an encryption/decryption and/or authentication unit or circuitry may be included at the end of the communication link in each of the device 212 and the apparatus 226. Other embodiments need not use encryption or authentication.

As used herein, the term CXL device broadly represents a device (e.g., of any of the types previously described) that supports at least one of the three device CXL protocols CXL.cache, CXL.mem, or CXL.io. In some embodiments, the CXL device may support at least the CXL.cache cache coherency protocol. The CXL device includes a controller (e.g., a device CXL.cache cache coherency protocol controller) 320 to implement a CXL.cache cache coherency protocol and/or perform CXL.cache cache coherency transactions. Similarly, the host processor includes a controller (e.g., a host CXL.cache cache coherency protocol controller) 342 to implement the CXL.cache cache coherency protocol and/or perform CXL.cache cache coherency transactions. The controllers may be used to perform cache coherent data exchanges between the CXL device and the host processor. In some embodiments, the CXL device may coherently write or store data 318 from the device cache 316 and/or data 319 from the device memory 317 to the host processor 326. Some embodiments may allow the CXL device 312 to cache coherently route this data to any one of a plurality of different specified or otherwise indicated destination locations of the host processor. In some embodiments, the CXL device may be able to flexibly specify or otherwise indicate that such data be steered, directed, or otherwise routed to any one of the LLC 330, the IOLLC 336, or the system memory 338. At least conceptually, this may represent adding DDIO-like data steering capabilities to the CXL.cache cache coherency protocol, where such DDIO-like data steering capabilities are currently not supported.

When the CXL device writes or stores the data to the host processor, the controller (e.g., the device CXL.cache cache coherency protocol controller) 320 may generate and/or transmit a first packet 322 toward the CXL link 324. The first packet may correspond to and/or be a packet of the CXL.cache cache coherency protocol. In some embodiments, the first packet may be a CXL.cache D2H (device to host) packet. In some embodiments, the CXL device may write or store the data based on performing a CXL.cache command. Examples of suitable CXL.cache commands include, but are not limited to, ItoMWR (having opcode 0 0110b), WOWrInv (having opcode 0 1100b), and WOWrInvF (having opcode 0 1101b). By way of example, the ItoMWr command may be used by the CXL device to request exclusive ownership of the cacheline address indicated in the address field of the packet and atomically write the cacheline back to the host processor. The CXL device may guarantee the entire cacheline line will be modified, so no data needs to be transferred to the CXL device. An example response is GO_WritePull. The GO_WritePull response may be sent once the request is granted ownership. The CXL device may not retain a copy of the cacheline. If a cache exists in the host processor cache hierarchy, then the data may be written there. If an error occurs, then a GO-Err-WritePull response may be sent instead. The CXL device may send the data to the host processor and the host processor may drop the data. The CXL device may take other actions to handle the error as appropriate. By way of example, the WOWrInv command may be used by the CXL device for a weakly ordered write invalidate line request of 0-63 bytes for write combining type stores. Various combinations of byte enables may be set. Commonly, WOWrInv may receive a FastGO-WritePull followed by an ExtCmp. Upon receiving the FastGO-WritePull the CXL device may send the data to the host processor. For host-attached memory, the host processor may send the ExtCmp once the write is complete in memory. FastGO may not provide “Global Observation.” In error conditions, a GO-Err-WritePull may be received. The CXL device may send the data as normal and the host processor may drop the data. The CXL device may take other actions to handle the error as appropriate. An ExtCmp may still be sent by the host processor after the GO-Err. The WOWrInvF command is like the WOWrInv command but is for a write of sixty-four bytes.

In some embodiments, the first packet (e.g., a CXL.cache D2H (device to host) packet) may include information (e.g., one or more bits) to specify or otherwise indicate one of multiple possible destination locations where the data is to be routed. In some embodiments, these one or more bits may be in a data header of the CXL.cache D2H (device to host) packet (e.g., corresponding to a ItoMWR command). In various embodiments, the one or more bits may be one, two, three, or optionally more than three bits. In various embodiments, the one or more bits may indicate any of at least one, two, three, four, or more than four different possible destination locations. In one example embodiment, the one or more bits may include a single bit that may have either a first binary value (e.g., be set to binary one) to indicate a first destination location or a second binary value (e.g., be cleared to binary zero) to indicate a second, different destination location. In another example embodiment, the one or more bits may include two bits that may have any one of a first binary value (e.g., 00) to indicate a first destination location (e.g., the LLC), a second binary value (e.g., 01) to indicate a second, different destination location (e.g., the IOLLC), a third binary value (e.g., 10) to indicate a third, still different destination location (e.g., the system memory), or a fourth binary value (e.g., 11) to indicate either a fourth, still different destination location or to indicate that no destination location is specified and/or that the host processor is allowed to choose on its own where the data is to be routed (e.g., a destination location fixed for the host processor, according to a fixed policy of the host processor, etc.). In yet another example embodiment, the one or more bits may include three or more bits to indicate additional destination locations (e.g., to indicate a specific core, to indicate a specific cache level within a specific indicated core, etc.).

Diverse types of bits may be used to indicate the destination location in different embodiments. In some embodiments, the one or more bits may include at least one bit that the CXL.cache cache coherency protocol specifies as being reserved (e.g., a reserved bit in a data header of a CXL.cache D2H (device to host) packet (e.g., corresponding to a ItoMWR command)). The CXL specification describes that bits or encodings that are not defined will be marked “Reserved” or “RSVD” and that these bits should be cleared to 0 by the sender of the packet and the receiver should ignore them, but in this new use these bits need not necessarily be set to zero and the receiver of the packet may ignore them and merely pass them along to the circuit which may examine and interpret them and understand them to be indicative of a destination location. One possible advantage of using one or more reserved bits is that the controllers 320, 342 may simply ignore these fields, which may optionally allow existing controllers to be used to implement the flexible routing to different destination locations even though the cache coherency protocol does not incorporate a mechanism for such flexible routing. In some embodiments, the one or more bits may include at least one bit that the CXL.cache cache coherency protocol defines or specifies for a different purpose than for the indication of the destination location and this bit may be repurposed for the indication of the destination location. As one example, the one or more bits may include a non-temporal (NT) bit in a data header of a CXL.cache D2H (device to host) packet (e.g., corresponding to a ItoMWR command) that the CXL.cache cache coherency protocol specifies should be used to indicate non-temporality (e.g., for purposes of evicting data from caches) rather than for the different purpose of indicating the destination location where the data is to be routed. Different combinations of these approaches are also possible. In some embodiments, the one or more bits may include any one, two, three, or more bits selected the following: (1) one or more bits that the CXL.cache cache coherency protocol specifies as being reserved; (2) one or more bits that the CXL.cache cache coherency protocol specifies for a different purpose than the indication of the destination location; (3) a bit that the CXL.cache cache coherency protocol specifics as a non-temporal (NT) bit; and (4) any combination thereof. In some embodiments, the destination location indicated by the one or more bits may depend upon an opcode of a command (e.g., ItoMWR having opcode 0 0110b, WOWrInv having opcode 0 1100b, or WOWrInvF having opcode 0 1101b) executed to transmit the data. For example, one or more bits having a given value may indicate a first destination location (e.g., the LLC) for a first command (e.g., a first opcode) whereas the one or more bits having the given value may indicate a second destination location (e.g., the IOLLC) for a second, different command (e.g., a second, different opcode).

The first packet 322 may be sent or transmitted from the CXL device 312 to the host processor 326 over the CXL link 324. The controller (e.g., the host CXL.cache cache coherency protocol controller) 342 may receive the first packet 322. The first packet may correspond to and/or be of the CXL.cache cache coherency protocol. In some embodiments, the first packet may be a CXL.cache D2H (device to host) packet. In some embodiments, the first packet may include the previously described information (e.g., the previously described one or more bits) to specify or otherwise indicate the destination location out of multiple possible destination locations where the data (e.g., the data 318 from the device cache or the data 319 from the device memory) is to be routed.

The host processor also includes circuitry 340 coupled with the controller 342 to receive the first packet 322. The circuitry may generate and output a second packet 344 corresponding to and/or of a different protocol (e.g., a fabric protocol) based on the first packet 322. The second packet may include information (e.g., one or more bits) to specify or otherwise indicate the same destination location that was indicated by the first packet. Since the first and second packets correspond to and/or are of different protocols the second packet will often use a different set of one or more bits (e.g., different bit positions in the packet) to indicate the destination location. In some embodiments, the destination location may be indicated in one or more steering tag (ST) bits of the second packets where these ST bits are also utilized to steer or route data for PCIe packets for DDIO, although the scope of the invention is not so limited. The circuitry may be aware of the one or more bits in the first packet, may examine and interpret the one or more bits in the first packet, may recognize a destination location indicated by the one or more bits in the first packet, and may include one or more bits or an indication or information in the second packet to indicate the same destination location.

The host processor also includes the fabric 334 (e.g., one or more buses or other interconnects) coupled with the circuitry 340 to receive the second packet 344. The fabric may route the data 318 from the device cache or the data 319 from the device memory to the destination location indicated by the second packet. For example, in some embodiments, the fabric may route the data to any one of the LLC, the IOLLC, or the system memory. In other embodiments, other destination locations may optionally be used, as previously described. Advantageously, the ability for the CXL device to flexibly indicate the destination location where the data is to be routed and for the host processor to use the indication to flexibly route the data to the indicated destination location may help to improve efficiency in at least some situations, such as, for example, by reducing data access latency, reducing the number of data transfers, reducing power consumption needed to access data, improving throughput, etc.

In FIG. 3, CXL.cache has been used as an exemplary cache coherency protocol for a communication link. However, it is to be appreciated that what is described for CXL.cache coherency protocol may optionally apply to future versions of the CXL.cache cache coherency protocol, modifications or variations of the CXL.cache cache coherency protocol, similar cache coherency protocols for communication links, and alternate or replacement cache coherency protocols for communication links. Also, as used herein, the terms CXL device, CXL link, and CXL.cache protocol broadly refer to devices, links, and protocols that either are CXL or are based on CXL, derived from CXL, modifications or variations of CXL, extensions of CXL, future versions of CXL, or the like, whether or not these devices, links, and protocols retain the name CXL or have been renamed.

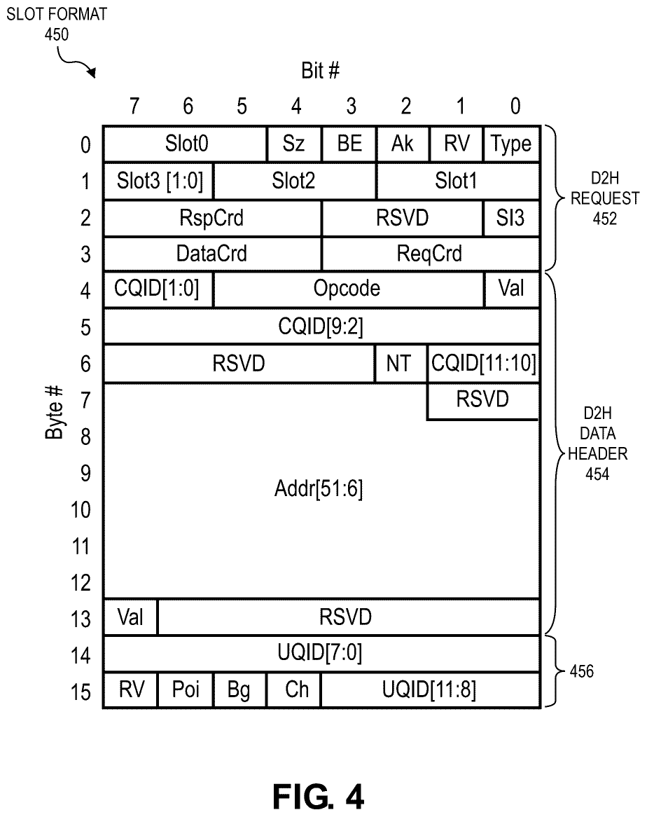

FIG. 4 is an example embodiment of a suitable slot format 450 for a CXL.cache flit and/or packet. The particular illustrated slot format is referred to in the CXL specification as slot format “H1-D2H Req+D2H Data Header.” The format includes a D2H request 452, a D2H data header 454, and terminal portion 456. The D2H request represents a new request that is being made (e.g., a request to subsequently write data). The D2H data header corresponds to data being written after having received approval for a previously made request (e.g., a D2H request in a previously sent packet). The D2H Request includes a number of fields that are shown for context but not particularly relevant to the present disclosure so they will not be described. Details of these fields, if desired, is available in the CXL specification. For this slot, the D2H data header is contained in bytes 4 to 13. A valid (Val) bit is included in bit 0 of byte 4. A 5-bit opcode is included in bits [5:1] of byte 4. A 12-bit Command Queue ID (CQID) includes two bits CQUID [1:0] in bits [7:6] of byte 4, eight bits CQID [9:2] in bits [7:0] of byte 5, and two bits CQID [11:10] in bits [1:0] of byte 6. A non-temporal (NT) bit is included in bit 2 of byte 6. In some embodiments, the NT bit may optionally be used alone or with one or more other bits to indicate a destination location. A 46-bit address Addr [51:6] is included in bits [7:2] of byte 7 and bytes 8 through 12. Reserved fields (RSVD) are included in bits [7:3] of byte 6, bits [1:0] of byte 7, and bits [6:0] of byte 13. In some embodiments, any one or more of these bits of the RSVD fields may optionally be used alone or with one or more other bits to indicate a destination location.

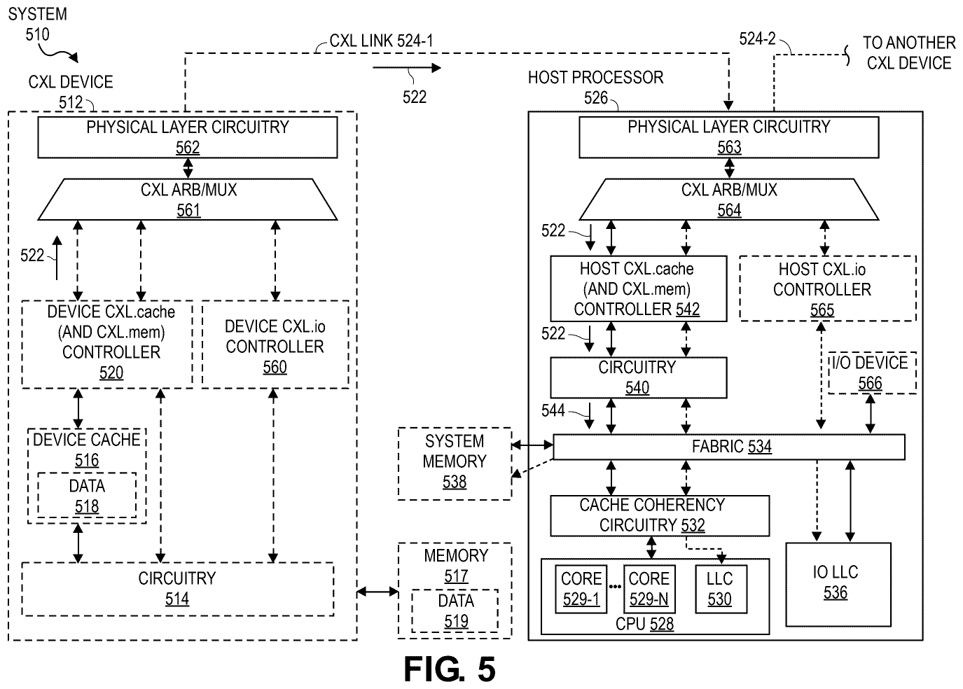

FIG. 5 is a block diagram of an embodiment of a computer system 510. The computer system includes an embodiment of a host processor 526 and an embodiment of a CXL device 512 that are coupled by a CXL link 524-1. The CXL device and the CXL link are shown in dashed lines to designate that some embodiments pertain to the host processor 526 alone (e.g., before the host processor is deployed in the computer system where it is coupled with the CXL device via the CXL link).

The host processor includes a CPU 528 having a plurality of cores 529-1 through 529-N and an LLC 530, a cache coherency circuitry 532, an IOLLC 536, a fabric 534, circuitry 540, and a host CXL.cache and CXL.mem controller 542. The CPU and its cores and LLC, the cache coherent circuitry, the IOLLC, and the circuitry 540 are coupled with the fabric. A system memory 538 is also coupled with the fabric. The controller 542 is coupled with the circuitry 540. The CXL device includes circuitry 514, a device cache 516 having data 518, and a device CXL.cache and CXL.mem controller 520. The device cache is coupled with the circuitry 514 and the device controller 520. Unless otherwise specified, the CPU 528, the LLC 530, the cache coherent circuitry 532, the IOLLC 536, the fabric 534, the circuitry 540, the host controller 542, the system memory 538, the circuitry 514, the device cache 516, and the device controller 520 may respectively optionally be similar to or the same as (e.g., have any one or more characteristics that are similar to or the same as) the corresponding CPU 228, LLC 230, cache coherent circuitry 232, IOLLC 236, fabric 234, circuitry 240, host controller 242, system memory 238, circuitry 214, device cache 216, and device controller 220 of FIG. 2 and/or to those of FIG. 3. Likewise, unless otherwise specified, the CXL device 512, the CXL link 524-1, and the host processor 526 may respectively optionally be similar to or the same as (e.g., have any one or more characteristics that are similar to or the same as) the device 212, the communication link 224, and the apparatus 226 of FIG. 2 or to the corresponding components of FIG. 3. For example, the computer system 510 may be of the same types previously described (e.g., server, desktop, etc.), the CXL device 512 may be of the same types previously described (e.g., GPUs, ASICs, FPGAs, may either be external/peripheral or in package on another chiplet, SoC, or die coupled by UCIe or another die-to-die interconnect to the die having the CPU, etc.), and so on. To avoid obscuring the description, the different and/or additional characteristics of the embodiment of FIG. 5 will primarily be described, without repeating all the characteristics that may optionally be the same as or similar to those already described for the embodiment of FIG. 2. Also, as previously described, in some embodiments, the communication link 224 may optionally be encrypted, authenticated, or both encrypted and authenticated, although this is not required. In such cases, a cryptographic unit or circuit (e.g., an encryption/decryption and/or authentication unit or circuitry may be included at the end of the communication link in each of the device 512 and the host processor 526. Other embodiments need not use encryption or authentication.

The CXL device of FIG. 5 also includes a device CXL.io controller 560 560, a CXL arbitration (ARB)/multiplexing (MUX) circuitry 561, and a physical layer circuitry (e.g., a Flex Bus™ physical layer circuitry) 562 coupled with the CLX ARB/MUX circuitry. The CLX ARB/MUX circuitry may perform protocol arbitration and multiplexing. For example, the CLX

ARB/MUX circuitry 561 may receive incoming data from the link layer and arbitrate or otherwise select a data stream for communication to the physical layer. The Flex Bus physical layer circuitry may be implemented as a flexible high-speed port that is statically configured to support either PCIe or CXL. The host processor of FIG. 5 also includes a physical layer circuitry 563 (e.g., a Flex Bus physical layer circuitry), a CLX ARB/MUX physical layer circuitry 564, and a host CLX.io controller 565, which may be similar or analogous to those of the CXL device.

### Example Computer Architectures.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are suitable.

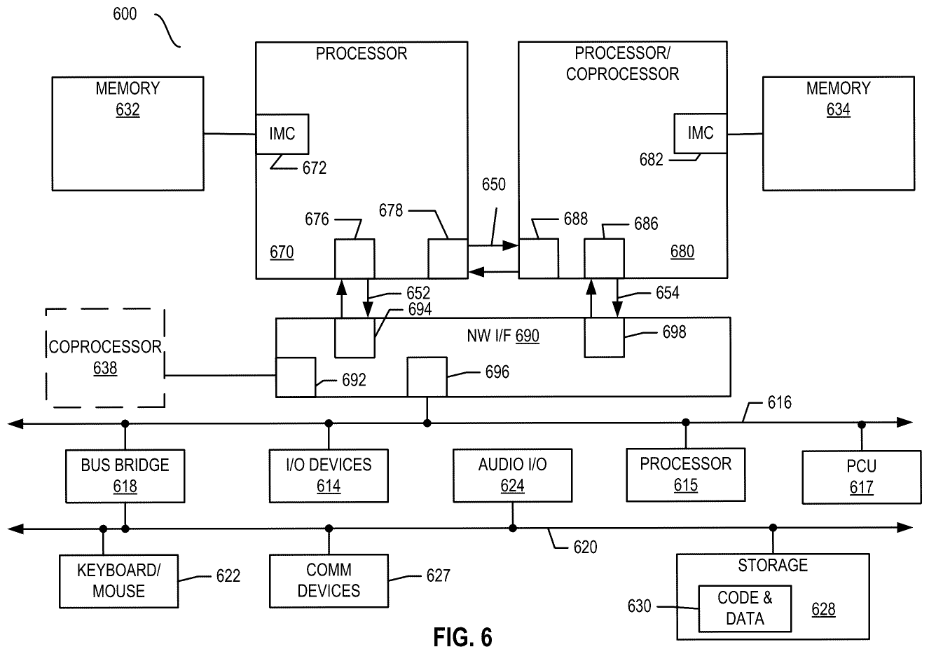

FIG. 6 illustrates an example computing system. Multiprocessor system 600 is an interfaced system and includes a plurality of processors or cores including a first processor 670 and a second processor 680 coupled via an interface 650 such as a point-to-point (P-P) interconnect, a fabric, and/or bus. In some examples, the first processor 670 and the second processor 680 are homogeneous. In some examples, the first processor 670 and the second processor 680 are heterogenous. Though the example system 600 is shown to have two processors, the system may have three or more processors, or may be a single processor system. In some examples, the computing system is a system on a chip (SoC).

Processors 670 and 680 are shown including integrated memory controller (IMC) circuitry 672 and 682, respectively. Processor 670 also includes interface circuits 676 and 678; similarly, second processor 680 includes interface circuits 686 and 688. Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW I/F) 690 via individual interfaces 652, 654 using interface circuits 676, 694, 686, 698. The network interface 690 (e.g., one or more of an interconnect, bus, and/or fabric, and in some examples is a chipset) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, the first interface 616 may be an interface such as a Peripheral Component Interconnect (PCI) interconnect, a PCI Express interconnect or another I/O interconnect. In some examples, the first interface 616 is coupled to a power control unit (PCU) 617, which may include circuitry, software, and/or firmware to perform power management operations regarding the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, the second interface 620 may be a low pin count (LPC) interface. Various devices may be coupled to second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement the storage 'ISAB03 in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

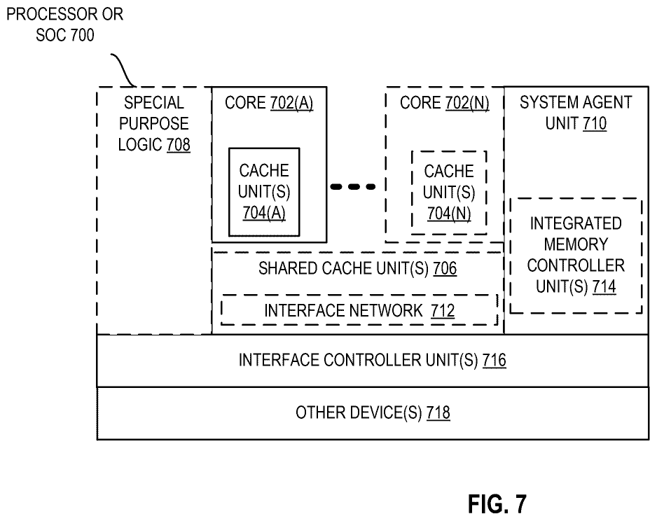

FIG. 7 illustrates a block diagram of an example processor and/or SoC 700 that may have one or more cores and an integrated memory controller. The solid lined boxes illustrate a processor 700 with a single core 702(A), system agent unit circuitry 710, and a set of one or more interface controller unit(s) circuitry 716, while the optional addition of the dashed lined boxes illustrates an alternative processor 700 with multiple cores 702(A)-(N), a set of one or more integrated memory controller unit(s) circuitry 714 in the system agent unit circuitry 710, and special purpose logic 708, as well as a set of one or more interface controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702(A)-(N) being one or more general purpose cores (e.g., general purpose in-order cores, general purpose out-of-order cores, or a combination of the two); 2) a coprocessor with the cores 702(A)-(N) being a large number of special purpose cores intended primarily for graphics and/or scientific (throughput); and 3) a coprocessor with the cores 702(A)-(N) being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 700 may be a part of and/or may be implemented on one or more substrates using any of several process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller unit's circuitry 716 couple the cores 702 to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

Example Core Architectures—in-Order and Out-of-Order Core Block Diagram.

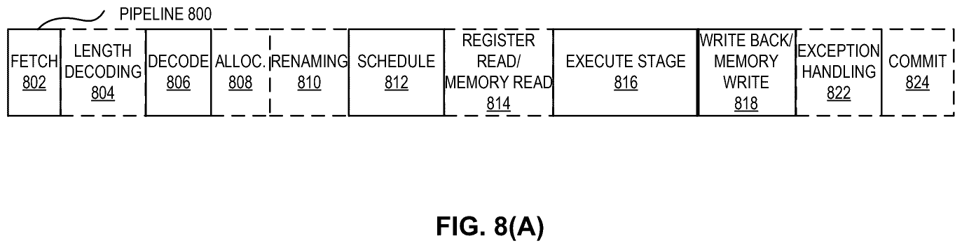

FIG. 8(A) is a block diagram illustrating both an example in-order pipeline and an example register renaming, out-of-order issue/execution pipeline according to examples. FIG. 8(B) is a block diagram illustrating both an example in-order architecture core and an example register renaming, out-of-order issue/execution architecture core to be included in a processor according to examples. The solid lined boxes in FIGS. 8(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8(A), a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 8(B) may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8(B) shows a processor core 890 including front-end unit circuitry 830 coupled to execution engine unit circuitry 850, and both are coupled to memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front-end unit circuitry 830 may include branch prediction circuitry 832 coupled to instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front-end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, address generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include several execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to data cache circuitry 874 coupled to level 2 (L2) cache circuitry 876. In one example, the memory access circuitry 864 may include load unit circuitry, store address unit circuitry, and store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Example Execution Unit(s) Circuitry.

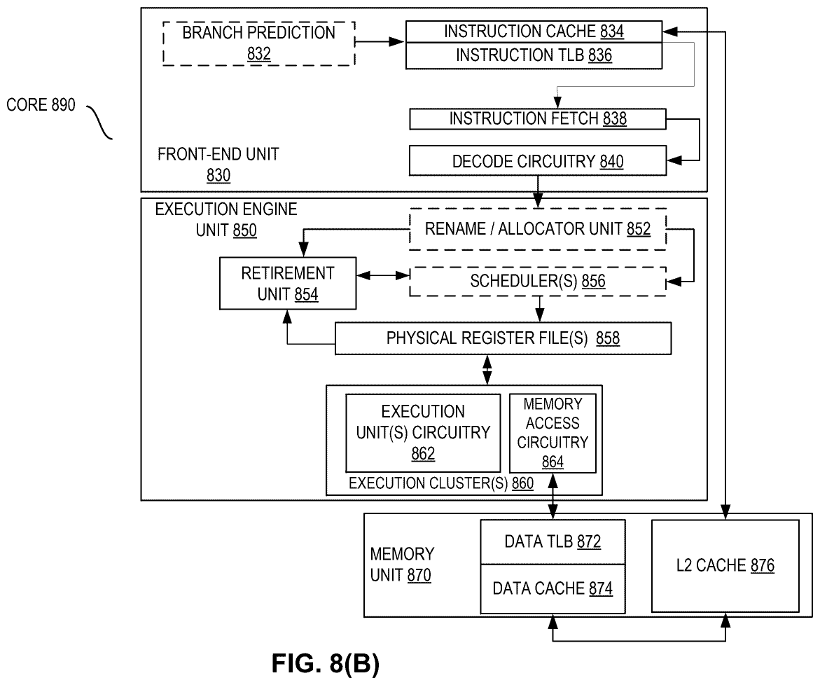

FIG. 9 illustrates examples of execution unit(s) circuitry, such as execution unit(s) circuitry 862 of FIG. 8(B). As illustrated, execution unit(s) circuitry 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

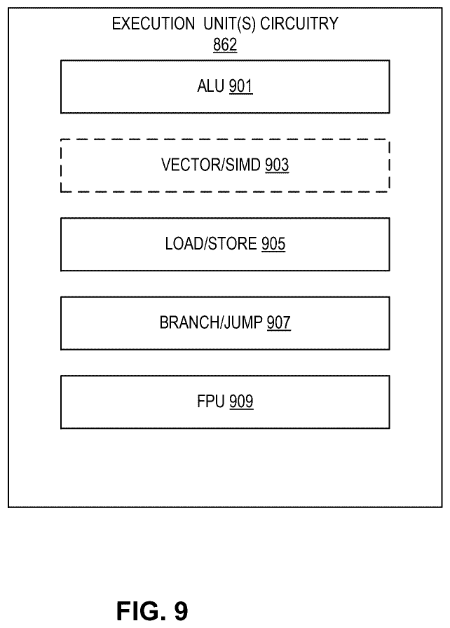

FIG. 10 is a block diagram of a register architecture 1000 according to some examples. As illustrated, the register architecture 1000 includes vector/SIMD registers 1010 that vary from 128-bit to 1,024 bits width. In some examples, the vector/SIMD registers 1010 are physically 512-bits and, depending upon the mapping, only some of the lower bits are used. For example, in some examples, the vector/SIMD registers 1010 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1000 includes writemask/predicate registers 1015. For example, in some examples, there are 8 writemask/predicate registers (sometimes called k0 through k7) that are each 16-bit, 32-bit, 64-bit, or 128-bit in size. Writemask/predicate registers 1015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1015 corresponds to a data element position of the destination. In other examples, the writemask/predicate registers 1015 are scalable and consists of a set number of enable bits for a given vector element (e.g., 8 enable bits per 64-bit vector element).

The register architecture 1000 includes a plurality of general-purpose registers 1025. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1000 includes scalar floating-point (FP) register file 1045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1040 (e.g., EFLAGS, RFLAGS, etc.) store status and control information for arithmetic, compare, and system operations. For example, the one or more flag registers 1040 may store condition code information such as carry, parity, auxiliary carry, zero, sign, and overflow. In some examples, the one or more flag registers 1040 are called program status and control registers.

Segment registers 1020 contain segment points for use in accessing memory. In some examples, these registers are referenced by the names CS, DS, SS, ES, FS, and GS.

Machine specific registers (MSRs) 1035 control and report on processor performance. Most MSRs 1035 handle system-related functions and are not accessible to an application program. Machine check registers 1060 consist of control, status, and error reporting MSRs that are used to detect and report on hardware errors.

One or more instruction pointer register(s) 1030 store an instruction pointer value. Control register(s) 1055 (e.g., CR0-CR4) determine the operating mode of a processor (e.g., processor 670, 680, 638, 615, and/or 700) and the characteristics of a currently executing task. Debug registers 1050 control and allow for the monitoring of a processor or core's debugging operations.

Memory (mem) management registers 1065 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1000 may, for example, be used in register file/memory 'ISAB08, or physical register file(s) circuitry 8 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source 1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

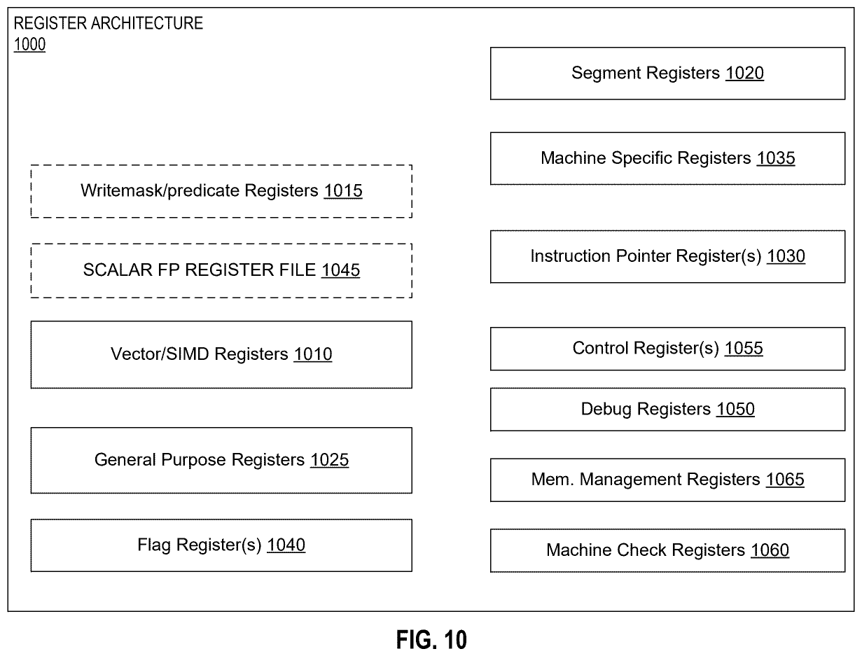

FIG. 11 illustrates examples of an instruction format. As illustrated, an instruction may include multiple components including, but not limited to, one or more fields for: one or more prefixes 1101, an opcode 1103, addressing information 1105 (e.g., register identifiers, memory addressing information, etc.), a displacement value 1107, and/or an immediate value 1109. Note that some instructions utilize some or all the fields of the format whereas others may only use the field for the opcode 1103. In some examples, the order illustrated is the order in which these fields are to be encoded, however, it should be appreciated that in other examples these fields may be encoded in a different order, combined, etc.

The prefix(es) field(s) 1101, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1103 is used to at least partially define the operation to be performed upon a decoding of the instruction. In some examples, a primary opcode encoded in the opcode field 1103 is one, two, or three bytes in length. In other examples, a primary opcode can be a different length. An additional 3-bit opcode field is sometimes encoded in another field.

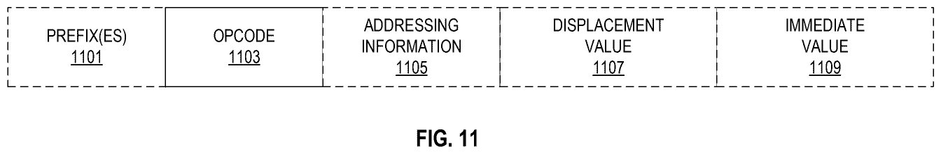

The addressing information field 1105 is used to address one or more operands of the instruction, such as a location in memory or one or more registers. FIG. 12 illustrates examples of the addressing information field 1105. In this illustration, an optional MOD R/M byte 1202 and an optional Scale, Index, Base (SIB) byte 1204 are shown. The MOD R/M byte 1202 and the SIB byte 1204 are used to encode up to two operands of an instruction, each of which is a direct register or effective memory address. Note that both fields are optional in that not all instructions include one or more of these fields. The MOD R/M byte 1202 includes a MOD field 1242, a register (reg) field 1244, and R/M field 1246.

The content of the MOD field 1242 distinguishes between memory access and non-memory access modes. In some examples, when the MOD field 1242 has a binary value of 11 (11b), a register-direct addressing mode is utilized, and otherwise a register-indirect addressing mode is used.

The register field 1244 may encode either the destination register operand or a source register operand or may encode an opcode extension and not be used to encode any instruction operand. The content of register field 1244, directly or through address generation, specifies the locations of a source or destination operand (either in a register or in memory). In some examples, the register field 1244 is supplemented with an additional bit from a prefix (e.g., prefix 1101) to allow for greater addressing.

The R/M field 1246 may be used to encode an instruction operand that references a memory address or may be used to encode either the destination register operand or a source register operand. Note the R/M field 1246 may be combined with the MOD field 1242 to dictate an addressing mode in some examples.

The SIB byte 1204 includes a scale field 1252, an index field 1254, and a base field 1256 to be used in the generation of an address. The scale field 1252 indicates a scaling factor. The index field 1254 specifies an index register to use. In some examples, the index field 1254 is supplemented with an additional bit from a prefix (e.g., prefix 1101) to allow for greater addressing. The base field 1256 specifies a base register to use. In some examples, the base field 1256 is supplemented with an additional bit from a prefix (e.g., prefix 1101) to allow for greater addressing. In practice, the content of the scale field 1252 allows for the scaling of the content of the index field 1254 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1107 provides this value. Additionally, in some examples, a displacement factor usage is encoded in the MOD field of the addressing information field 1105 that indicates a compressed displacement scheme for which a displacement value is calculated and stored in the displacement field 1107.

In some examples, the immediate value field 1109 specifies an immediate value for the instruction. An immediate value may be encoded as a 1-byte value, a 2-byte value, a 4-byte value, etc.

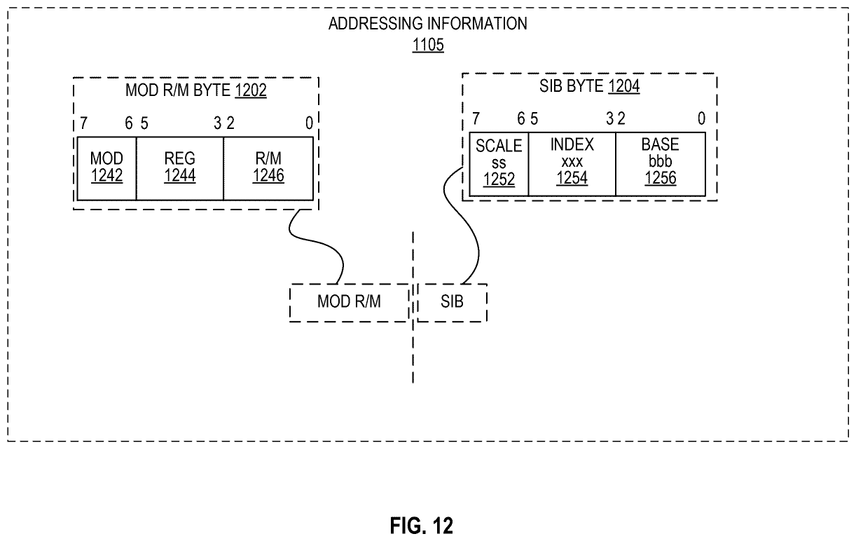

FIG. 13 illustrates examples of a first prefix 1101(A). In some examples, the first prefix 1101(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1101(A) may specify up to three registers using 3-bit fields depending on the format: 1) using the reg field 1244 and the R/M field 1246 of the MOD R/M byte 1202; 2) using the MOD R/M byte 1202 with the SIB byte 1204 including using the reg field 1244 and the base field 1256 and index field 1254; or 3) using the register field of an opcode.

In the first prefix 1101(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1244 and MOD R/M R/M field 1246 alone can each only address 8 registers.

In the first prefix 1101(A), bit position 2 (R) may be an extension of the MOD R/M reg field 1244 and may be used to modify the MOD R/M reg field 1244 when that field encodes a general-purpose register, a 64-bit packed data register (e.g., a SSE register), or a control or debug register. R is ignored when MOD R/M byte 1202 specifies other registers or defines an extended opcode.

Bit position 1 (X) may modify the SIB byte index field 1254.

Bit position 0 (B) may modify the base in the MOD R/M R/M field 1246 or the SIB byte base field 1256; or it may modify the opcode register field used for accessing general purpose registers (e.g., general purpose registers 1025).

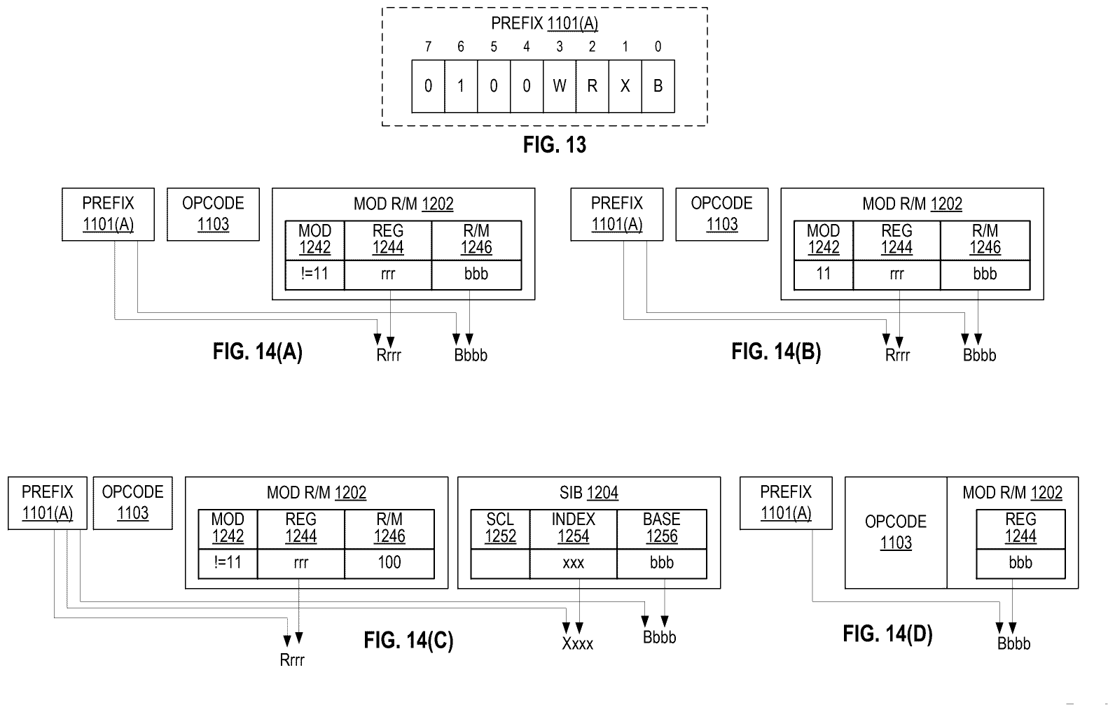

FIGS. 14(A)-(D) illustrate examples of how the R, X, and B fields of the first prefix 1101(A) are used. FIG. 14(A) illustrates R and B from the first prefix 1101(A) being used to extend the reg field 1244 and R/M field 1246 of the MOD R/M byte 1202 when the SIB byte 12 04 is not used for memory addressing. FIG. 14(B) illustrates R and B from the first prefix 1101(A) being used to extend the reg field 1244 and R/M field 1246 of the MOD R/M byte 1202 when the SIB byte 12 04 is not used (register-register addressing). FIG. 14(C) illustrates R, X, and B from the first prefix 1101(A) being used to extend the reg field 1244 of the MOD R/M byte 1202 and the index field 1254 and base field 1256 when the SIB byte 12 04 being used for memory addressing. FIG. 14(D) illustrates B from the first prefix 1101(A) being used to extend the reg field 1244 of the MOD R/M byte 1202 when a register is encoded in the opcode 1103.

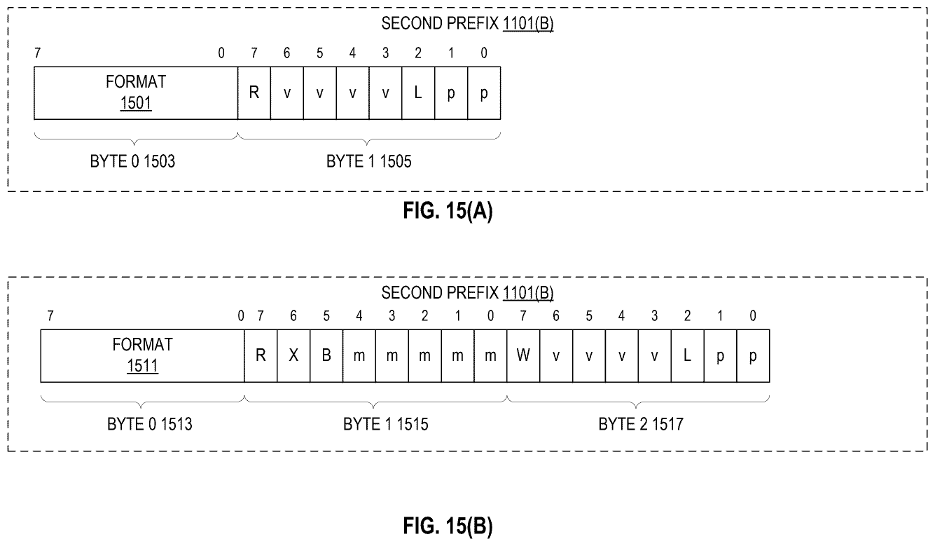

FIGS. 15(A)-(B) illustrate examples of a second prefix 1101(B). In some examples, the second prefix 1101(B) is an example of a VEX prefix. The second prefix 1101(B) encoding allows instructions to have more than two operands, and allows SIMD vector registers (e.g., vector/SIMD registers 1010) to be longer than 64-bits (e.g., 128-bit and 256-bit). The use of the second prefix 1101(B) provides for three-operand (or more) syntax. For example, previous two-operand instructions performed operations such as A=A+B, which overwrites a source operand.

The use of the second prefix 1101(B) enables operands to perform nondestructive operations such as A=B+C.

In some examples, the second prefix 1101(B) comes in two forms—a two-byte form and a three-byte form. The two-byte second prefix 1101(B) is used mainly for 128-bit, scalar, and some 256-bit instructions; while the three-byte second prefix 1101(B) provides a compact replacement of the first prefix 1101(A) and 3-byte opcode instructions.

FIG. 15(A) illustrates examples of a two-byte form of the second prefix 1101(B). In one example, a format field 1501 (byte 0 1503) contains the value C5H. In one example, byte 1 1505 includes an “R” value in bit[7]. This value is the complement of the “R” value of the first prefix 1101(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (Is complement) form and valid for instructions with 2 or more source operands; 2) encode the destination register operand, specified in Is complement form for certain vector shifts; or 3) not encode any operand, the field is reserved and should contain a certain value, such as 1111b.

Instructions that use this prefix may use the MOD R/M R/M field 1246 to encode the instruction operand that references a memory address or encode either the destination register operand or a source register operand.

Instructions that use this prefix may use the MOD R/M reg field 1244 to encode either the destination register operand or a source register operand, or to be treated as an opcode extension and not used to encode any instruction operand.

For instruction syntax that supports four operands, vvvv, the MOD R/M R/M field 1246 and the MOD R/M reg field 1244 encode three of the four operands. Bits[7:4] of the immediate value field 1109 are then used to encode the third source register operand.

FIG. 15(B) illustrates examples of a three-byte form of the second prefix 1101(B). In one example, a format field 1511 (byte 0 1513) contains the value C4H. Byte 1 1515 includes in bits [7:5] “R,” “X,” and “B” which are the complements of the same values of the first prefix 1101(A). Bits[4:0] of byte 1 1515 (shown as mmmmm) include content to encode, as need, one or more implied leading opcode bytes. For example, 00001 implies a OFH leading opcode, 00010 implies a OF38H leading opcode, 00011 implies a OF3AH leading opcode, etc.

Bit[7] of byte 2 1517 is used like W of the first prefix 1101(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (Is complement) form and valid for instructions with 2 or more source operands; 2) encode the destination register operand, specified in Is complement form for certain vector shifts; or 3) not encode any operand, the field is reserved and should contain a certain value, such as 1111b.

Instructions that use this prefix may use the MOD R/M R/M field 1246 to encode the instruction operand that references a memory address or encode either the destination register operand or a source register operand.

Instructions that use this prefix may use the MOD R/M reg field 1244 to encode either the destination register operand or a source register operand, or to be treated as an opcode extension and not used to encode any instruction operand.

For instruction syntax that supports four operands, vvvv, the MOD R/M R/M field 1246, and the MOD R/M reg field 1244 encode three of the four operands. Bits[7:4] of the immediate value field 1109 are then used to encode the third source register operand.

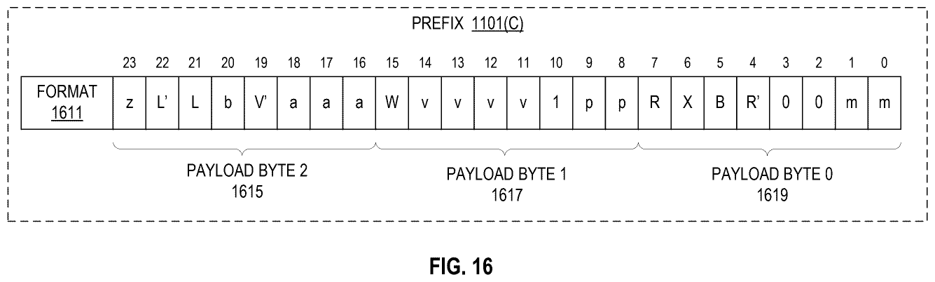

FIG. 16 illustrates examples of a third prefix 1101(C). In some examples, the third prefix 1101(C) is an example of an EVEX prefix. The third prefix 1101(C) is a four-byte prefix.

The third prefix 1101(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 10) or predication utilize this prefix. Opmask register allows for conditional processing or selection control. Opmask instructions, whose source/destination operands are opmask registers and treat the content of an opmask register as a single value, are encoded using the second prefix 1101(B).

The third prefix 1101(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1101(C) is a format field 1611 that has a value, in one example, of 62H. Subsequent bytes are referred to as payload bytes 1615-1619 and collectively form a 24-bit value of P[23:0] providing specific capability in the form of one or more fields (detailed herein).

In some examples, P[1:0] of payload byte 1619 are identical to the low two mm bits. P[3:2] are reserved in some examples. Bit P[4] (R′) allows access to the high 16 vector register set when combined with P[7] and the MOD R/M reg field 1244. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1244 and MOD R/M R/M field 1246. P[9:8] provides opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in Is complement form for certain vector shifts; or 3) not encode any operand, the field is reserved and should contain a certain value, such as 1111b.

P[15] is like W of the first prefix 1101(A) and second prefix 1111(B) and may serve as an opcode extension bit or operand size promotion.

P[18:16] specify the index of a register in the opmask (writemask) registers (e.g., writemask/predicate registers 1015). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differ across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1101(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or |
| | | | reg | | Source |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination |
| | | | or Source |
| VVVV | vvvv | GPR, Vector | 2^{nd} Source or |
| | | | Destination |
| RM | MOD R/M R/M | GPR, Vector | 1^{st} Source or |
| | | | Destination |
| BASE | MOD R/M R/M | GPR | Memory addressing |
| INDEX | SIB.index | GPR | Memory addressing |
| VIDX | SIB.index | Vector | VSIB memory |
| | | | addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors, and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

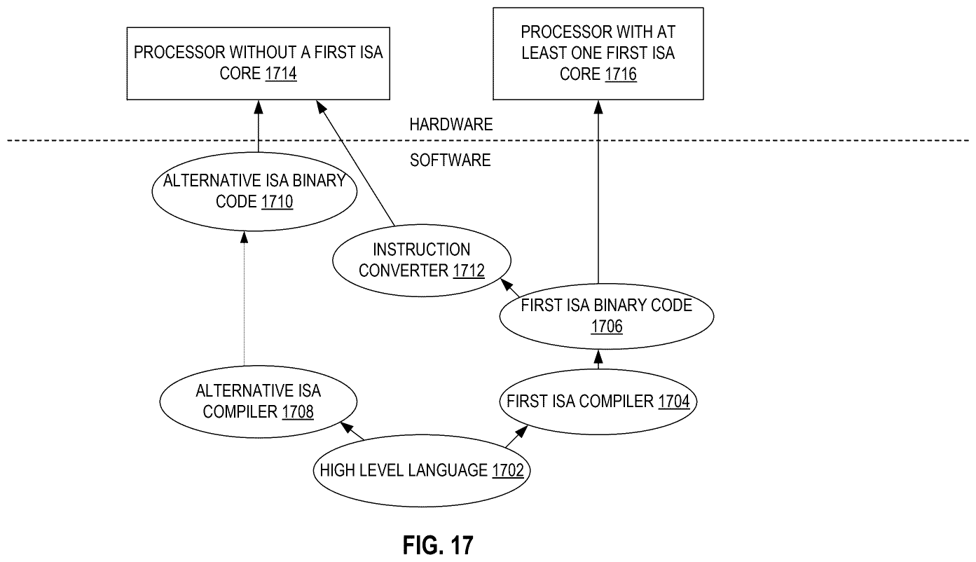

FIG. 17 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 17 shows a program in a high-level language 1702 may be compiled using a first ISA compiler 1704 to generate first ISA binary code 1706 that may be natively executed by a processor with at least one first ISA core 1716. The processor with at least one first ISA core 1716 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1704 represents a compiler that is operable to generate the first ISA binary code 1706 (e.g., object code) that can, with or without additional linkage processing, be executed on the processor with at least one first ISA core 1716. Similarly, FIG. 17 shows the program in the high-level language 1702 may be compiled using an alternative ISA compiler 1708 to generate alternative ISA binary code 1710 that may be natively executed by a processor without a first ISA core 1714. The instruction converter 1712 is used to convert the first ISA binary code 1706 into code that may be natively executed by the processor without a first ISA core 1714. This converted code is not necessarily to be the same as the alternative ISA binary code 1710; however, the converted code will accomplish the general operation and be made up of instructions from the alternative ISA. Thus, the instruction converter 1712 represents software, firmware, hardware, or a combination thereof that, through emulation, simulation, or any other process, allows a processor or other electronic device that does not have a first ISA processor or core to execute the first ISA binary code 1706.

Components, features, and details described for any of FIGS. 3-5 may also optionally apply to any of FIGS. 1-2. Components, features, and details described for any of the apparatus disclosed herein (e.g., apparatus 226, host processor 326) may optionally apply to any of the methods disclosed herein (e.g., method 100), which in embodiments may optionally be performed by and/or with such apparatus. Any of the apparatus described herein (e.g., apparatus 226, host processor 326) in embodiments may optionally be included in any of the systems disclosed herein.

References to “one example,” “an example,” etc., indicate that the example described may include a particular feature, structure, or characteristic, but every example may not necessarily include the particular feature, structure, or characteristic. Moreover, such phrases do not necessarily refer to the same example. Further, when a particular feature, structure, or characteristic is described in connection with an example, it is submitted that it is within the knowledge of one skilled in the art to affect such feature, structure, or characteristic in connection with other examples whether explicitly described.

Apparatus disclosed herein may be said and/or claimed to be operative, operable, capable, able, configured adapted, or otherwise to perform an operation. As used herein, these expressions refer to the characteristics, properties, or attributes of the components when in a powered-off state, and do not imply that the components or the device or apparatus in which they are included is currently powered on or operating. For clarity, it is to be understood that the processors and apparatus claimed herein are not claimed as being powered on or running.

In the description and claims, the terms “coupled” and/or “connected,” along with their derivatives, may have been used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, yet still co-operate or interact with each other. For example, an execution unit may be coupled with a register and/or a decode unit through one or more intervening components. In the figures, arrows are used to show connections and couplings.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical, or other form of propagated signals-such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches), Mobile Internet devices (MIDs), media players, smart televisions, nettops, set-top boxes, and video game controllers.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

In the description above, specific details have been set forth to provide a thorough understanding of the embodiments. However, other embodiments may be practiced without some of these specific details. Various modifications and changes may be made thereunto without departing from the broader spirit and scope of the disclosure as set forth in the claims. The specification and drawings are, accordingly, to be regarded in an illustrative rather than a restrictive sense. The scope of the invention is not to be determined by the specific examples provided above, but only by the claims below. In other instances, well-known circuits, structures, devices, and operations have been shown in block diagram form and/or without detail to avoid obscuring the understanding of the description.

### Example Embodiments

The following examples pertain to further embodiments. Specifics in the examples may be used anywhere in one or more embodiments.

Example 1 is an apparatus including a cache coherency protocol controller to receive a first packet of a cache coherency protocol that is to have been transmitted from a device over a communication link. The first packet is to have one or more bits to indicate a destination location where data from the device is to be routed. The apparatus also includes circuitry coupled with the cache coherency protocol controller to receive the first packet. The circuitry is to generate a second packet based on the first packet. The second packet is to indicate the destination location. The apparatus also includes a fabric coupled with the circuitry to receive the second packet. The fabric to route the data to the destination location indicated by the second packet.

Example 2 includes the apparatus of Example 1, optionally where the cache coherency protocol is a CXL.cache cache coherency protocol and/or optionally where the first packet is a CXL.cache D2H (device to host) packet.

Example 3 includes the apparatus of any one of Examples 1 to 2, where the one or more bits comprise at least one bit that the cache coherency protocol specifies is reserved.

Example 4 includes the apparatus of any one of Examples 1 to 3, where the one or more bits comprise at least one bit that the cache coherency protocol specifies for a different purpose than for the indication of the destination location.

Example 5 includes the apparatus of any one of Examples 1 to 4, where the one or more bits comprise a bit that the cache coherency protocol specifies as a non-temporal (NT) bit.

Example 6 includes the apparatus of any one of Examples 1 to 5, optionally where the communication link includes a Universal Chiplet Interconnect (UCIe) Express link and/or optionally where the one or more bits comprise a plurality of bits selected from a group consisting of one or more bits that the cache coherency protocol specifies is reserved, one or more bits that the cache coherency protocol specifies for a different purpose than for the indication of the destination location, a bit that the cache coherency protocol specifies as a non-temporal (NT) bit, and any combination thereof.

Example 7 includes the apparatus of any one of Examples 1 to 6, optionally further including a cryptographic unit to authenticate the device and to decrypt an encrypted packet to generate the first packet and/or optionally where the destination location indicated by the one or more bits depends upon an opcode of a command executed to cause the data to be sent from the device.

Example 8 includes the apparatus of any one of Examples 1 to 7, where the one or more bits are to have a first value to indicate the destination location as a last level cache of a central processing unit (CPU) and the one or more bits are to have a second, different value to indicate the destination location as an input/output last level cache (IOLLC).

Example 9 is a host processor including a host CXL.cache controller to receive a CXL.cache D2H (device to host) packet of a CXL.cache cache coherency protocol that is to have been transmitted from a Compute Express Link (CXL) device over a CXL link. The CXL.cache D2H packet has one or more bits to indicate destination location where data from the CXL device is to be routed. The host processor also includes circuitry coupled with the host CXL.cache controller to receive the CXL.cache D2H packet. The circuitry is to generate a second packet based on the CXL.cache D2H packet. The second packet is to indicate the destination location. The host processor also includes a fabric coupled with the circuitry to receive the second packet. The fabric is to route the data to the destination location indicated by the second packet.

Example 10 includes the host processor of Example 9, where the one or more bits comprise at least one bit that the CXL.cache cache coherency protocol specifies is reserved.

Example 11 includes the host processor of any one of Examples 9 to 10, where the one or more bits comprise at least one bit that the CXL.cache cache coherency protocol specifies for a different purpose than for the indication of the destination location.

Example 12 includes the host processor of any one of Examples 9 to 11, where the one or more bits comprise a bit that the CXL.cache cache coherency protocol specifies as a non-temporal (NT) bit.

Example 13 includes the host processor of any one of Examples 9 to 12, where the one or more bits comprise a plurality of bits selected from a group consisting of one or more bits that the CXL.cache cache coherency protocol specifies is reserved, one or more bits that the CXL.cache cache coherency protocol specifies for a different purpose than for the indication of the destination location, a bit that the CXL.cache cache coherency protocol specifies as a non-temporal (NT) bit, and any combination thereof.

Example 14 includes the host processor of any one of Examples 9 to 13, where the destination location indicated by the one or more bits depends upon an opcode of a command executed to cause the data to be sent from the CXL device.

Example 15 includes the host processor of any one of Examples 9 to 14, where the one or more bits are to have a first value to indicate the destination location as a last level cache of a central processing unit (CPU) and the one or more bits are to have a second, different value to indicate the destination location as an input/output last level cache (IOLLC).

Example 16 is a method including receiving a first packet of a cache coherency protocol transmitted from a device over a communication link. The first packet has one or more bits indicating a destination location where data from the device is to be routed. The method also includes generating a second packet based on the first packet. The second packet indicating the destination location. The method also includes routing the data to the destination location indicated by the second packet.

Example 17 includes the method of Example 16, optionally where receiving the first packet includes receiving a CXL.cache D2H (device to host) packet and/or optionally where the one or more bits indicate the destination location as any one of at least a last level cache of a central processing unit (CPU) and an input/output last level cache (IOLLC).

Example 18 includes the method of any one of Examples 16 to 17, where the one or more bits comprise at least one bit that the cache coherency protocol specifies is reserved.

Example 19 includes the method of any one of Examples 16 to 18, optionally further including authenticating the device and decrypting an encrypted packet to generate the first packet and/or optionally where the one or more bits comprise at least one bit that the cache coherency protocol specifies for a different purpose than for the indication of the destination location.

Example 20 includes the method of any one of Examples 16 to 19, where the one or more bits comprise a bit that the cache coherency protocol specifies as a non-temporal (NT) bit.

Example 21 is a processor or other apparatus operative to perform the method of any one of Examples 16 to 20.

Example 22 is a processor or other apparatus that includes means for performing the method of any one of Examples 16 to 20.

Example 23 is a processor or other apparatus that includes any combination of modules and/or units and/or logic and/or circuitry and/or means operative to perform the method of any one of Examples 16 to 20.

Example 24 is an optionally non-transitory and/or tangible machine-readable medium, which optionally stores or otherwise provides instructions including a first instruction, the first instruction if and/or when executed by a processor, computer system, electronic device, or other machine, is operative to cause the machine to perform the method of any one of Examples 16 to 20.

What is claimed is:

1. An apparatus comprising:
a cache coherency protocol controller to receive a first packet of a cache coherency protocol that is to have been transmitted from a device over a communication link, the first packet having one or more bits to indicate a destination location where data from the device is to be routed;
circuitry coupled with the cache coherency protocol controller to receive the first packet, the circuitry to generate a second packet based on the first packet, the second packet to indicate the destination location; and
a fabric coupled with the circuitry to receive the second packet, the fabric to route the data to the destination location indicated by the second packet.

2. The apparatus of claim 1, wherein the cache coherency protocol is a CXL.cache cache coherency protocol, and wherein the first packet is a CXL.cache D2H (device to host) packet.

3. The apparatus of claim 1, wherein the one or more bits comprise at least one bit that the cache coherency protocol specifies is reserved.

4. The apparatus of claim 1, wherein the one or more bits comprise at least one bit that the cache coherency protocol specifies for a different purpose than for the indication of the destination location.

5. The apparatus of claim 1, wherein the one or more bits comprise a bit that the cache coherency protocol specifies as a non-temporal (NT) bit.

6. The apparatus of claim 1, wherein the communication link comprises a Universal Chiplet Interconnect (UCIe) Express link, and wherein the one or more bits comprise a plurality of bits selected from a group consisting of one or more bits that the cache coherency protocol specifies is reserved, one or more bits that the cache coherency protocol specifies for a different purpose than for the indication of the destination location, a bit that the cache coherency protocol specifies as a non-temporal (NT) bit, and any combination thereof.

7. The apparatus of claim 1, further comprising a cryptographic unit to authenticate the device and to decrypt an encrypted packet to generate the first packet, and wherein the destination location indicated by the one or more bits depends upon an opcode of a command executed to cause the data to be sent from the device.

8. The apparatus of claim 1, wherein the one or more bits are to have a first value to indicate the destination location as a last level cache of a central processing unit (CPU) and the one or more bits are to have a second, different value to indicate the destination location as an input/output last level cache (IOLLC).

9. A host processor comprising:
a host CXL.cache controller to receive a CXL.cache D2H (device to host) packet of a CXL.cache cache coherency protocol that is to have been transmitted from a Compute Express Link (CXL) device over a CXL link, the CXL.cache D2H packet having one or more bits to indicate a destination location where data from the CXL device is to be routed;
circuitry coupled with the host CXL.cache controller to receive the CXL.cache D2H packet, the circuitry to generate a second packet based on the CXL.cache D2H packet, the second packet to indicate the destination location; and
a fabric coupled with the circuitry to receive the second packet, the fabric to route the data to the destination location indicated by the second packet.

10. The apparatus of claim 9, wherein the one or more bits comprise at least one bit that the CXL.cache cache coherency protocol specifies is reserved.

11. The apparatus of claim 9, wherein the one or more bits comprise at least one bit that the CXL.cache cache coherency protocol specifies for a different purpose than for the indication of the destination location.

12. The apparatus of claim 9, wherein the one or more bits comprise a bit that the CXL.cache cache coherency protocol specifies as a non-temporal (NT) bit.

13. The apparatus of claim 9, wherein the one or more bits comprise a plurality of bits selected from a group consisting of one or more bits that the CXL.cache cache coherency protocol specifies is reserved, one or more bits that the CXL.cache cache coherency protocol specifies for a different purpose than for the indication of the destination location, a bit that the CXL.cache cache coherency protocol specifies as a non-temporal (NT) bit, and any combination thereof.

14. The apparatus of claim 9, wherein the destination location indicated by the one or more bits depends upon an opcode of a command executed to cause the data to be sent from the CXL device.

15. The apparatus of claim 9, wherein the one or more bits are to have a first value to indicate the destination location as a last level cache of a central processing unit (CPU) and the one or more bits are to have a second, different value to indicate the destination location as an input/output last level cache (IOLLC).

16. A method comprising:
receiving a first packet of a cache coherency protocol transmitted from a device over a communication link, the first packet having one or more bits indicating a destination location where data from the device is to be routed;
generating a second packet based on the first packet, the second packet indicating the destination location; and
routing the data to the destination location indicated by the second packet.

17. The method of claim 16, wherein receiving the first packet comprises receiving a CXL.cache D2H (device to host) packet, and wherein the one or more bits indicate the destination location as any one of at least a last level cache of a central processing unit (CPU) and an input/output last level cache (IOLLC).

18. The method of claim 16, wherein the one or more bits comprise at least one bit that the cache coherency protocol specifies is reserved.

19. The method of claim 16, further comprising:
authenticating the device; and
decrypting an encrypted packet to generate the first packet, wherein the one or more bits comprise at least one bit that the cache coherency protocol specifies for a different purpose than for the indication of the destination location.

20. The method of claim 16, wherein the one or more bits comprise a bit that the cache coherency protocol specifies as a non-temporal (NT) bit.
